(19) United States
(12) Patent Application Publication
(10) Pub. No.: US 2003/0080253 A1
(43) Pub. Date: May 1, 2003

(54) Anti-icing system

(76) Inventor: Lowell E. Tillman II, Halls, TN (US)

Correspondence Address: Michael S. Neustel, Suite No. 4, 2534 South University Drive, Fargo, ND, 58103, US

(21) Appl. No.: 10/037,095

(22) Filed: Oct. 25, 2001

(51) Int. Cl. B64D 15/00

(52) U.S. Cl. 244/134 R

(57) ABSTRACT

An anti-icing system for inhibiting the formation of ice upon the leading edge of an aircraft wing during flight. The anti-icing system includes an elongate support member that is attachable to a leading edge of an aircraft wing, and a plurality of flexible fibers secured within the elongate support member. The flexible fibers oscillate and move about the surface of the leading edge and portions of the top surface of the wing during flight due to the airflow about the wing. The movement of the flexible fibers moves accumulated water thereby assisting in the dispersing of the water from the wing and reducing the likelihood of the water freezing upon the wing. The movement of the flexible fibers also assists in removing any accumulated ice upon the wing prior to flight. The flexible fibers are preferably constructed of a flexible material such as but not limited to plastic.

### STATEMENT REGARDING FEDERALLY SPONSORED RESEARCH OR DEVELOPMENT

Not applicable to this application.

### CROSS REFERENCE TO RELATED APPLICATIONS

Not applicable to this application.

### BACKGROUND OF THE INVENTION

1. Field of the Invention

The present invention relates generally to aircraft anti-icing systems and more specifically it relates to an anti-icing system for inhibiting the formation of ice upon the leading edge of an aircraft wing during flight.

2. Description of the Prior Art

Aircraft deicing and anti-icing systems have been in use for years which are basically comprised of fluids applied to the aircraft wing on the ground. Deicing fluids are designed to safely remove frost, snow and ice from an aircraft prior to flight. Deicing fluids may be used upon all fixed wing, metal aircraft, including piston, turboprop, and jet aircraft. Deicing fluid is typically sprayed hot directly onto the aircraft surfaces from a handheld or powered deicing sprayer. The deicing fluid removes frost, snow and ice by thermal action and by lowering the freezing point of the frozen layer upon the aircraft. Each formulation of deicing fluid has a known freeze point. An application “buffer” of at least 18 Fahrenheit between the known freeze point of the deicing fluid and the ambient air temperature is typically required before applying a deicing solution.

Anti-icing solutions are designed to be used on contaminate-free, metal, fixed-wing aircraft (after deicing operations or when the aircraft has been hangered) to delay the accumulation of frost, snow and ice while on the ramp and taxiing for takeoff. SAE Type II and IV anti-icing fluids represent a significant improvement in anti-icing protection and provide dramatically increased “holdover time” versus the SAE Type I deicing fluids. Anti-Icing fluids are typically sprayed undiluted and cold, directly onto the aircraft's critical components, particularly the upper wing and horizontal stabilizer surfaces. Because Type II and IV fluids are much more viscous than the Type I deicing fluids, they tend to cling to the aircraft surfaces rather than running off, and may be applied to a much thicker layer. As such, they absorb and liquefy the continuing frozen precipitation, helping prevent their further accumulation on the aircraft. Since the anti-icing fluid remains on the aircraft, they must be removed by the shearing effect of wind velocity on the takeoff roll, Type II and IV anti-icing fluids are applicable only to aircraft with a rotation speed of 85 knots or more, and specifically with the aircraft manufacturer's approval.

One problem with conventional deicing and anti-icing systems is that the residual fluid left upon the aircraft wing can freeze upon the wing during flight. Another problem is that anti-icing fluid is unable to provide infinite protection against icing during extended aircraft flights. A further problem is that a deicing solution may not be applied unless there is a sufficient buffer between the known freeze point of the deicing solution and the ambient air temperature. In addition, deicing solutions provide little or no protection to an aircraft during flight as is well known. Anti-icing solutions may only be utilized upon aircraft that have a sufficient velocity to remove the anti-icing solution during take-off. Finally, neither anti-icing nor deicing fluids provide significant protection against icing during flights.

Examples of patented devices which are related to the present invention include U.S. Pat. No. 6,076,776 to Breitbach, et al; U.S. Pat. No. 4,732,351 to Bird; U.S. Pat. No. 5,925,275 to Lawson, et al; U.S. Pat. No. 6,052,056 to Burns, et al; U.S. Pat. No. 5,955,887 to Codner, et al; U.S. Pat. No. 5,748,091 to Kim; U.S. Pat. No. 5,523,959 to Seegmiller; U.S. Pat. No. 5,484,121 to Padawer, et al; U.S. Pat. No. 5,394,340 to Inkpen, et al; and U.S. Pat. No. 5,206,806 to Gerardi, et al.

While these devices may be suitable for the particular purpose to which they address, they are not as suitable for inhibiting the formation of ice upon the leading edge of an aircraft wing during flight. Conventional anti-icing systems are not suitable for sustained anti-icing capabilities during flight.

In these respects, the anti-icing system according to the present invention substantially departs from the conventional concepts and designs of the prior art, and in so doing provides an apparatus primarily developed for the purpose of inhibiting the formation of ice upon the leading edge of an aircraft wing during flight.

### SUMMARY OF THE INVENTION

In view of the foregoing disadvantages inherent in the known types of anti-icing systems now present in the prior art, the present invention provides a new anti-icing system construction wherein the same can be utilized for inhibiting the formation of ice upon the leading edge of an aircraft wing during flight.

The general purpose of the present invention, which will be described subsequently in greater detail, is to provide a new anti-icing system that has many of the advantages of the anti-icing systems mentioned heretofore and many novel features that result in a new anti-icing system which is not anticipated, rendered obvious, suggested, or even implied by any of the prior art anti-icing systems, either alone or in any combination thereof.

To attain this, the present invention generally comprises an elongate support member that is attachable to a leading edge of an aircraft wing, and a plurality of flexible fibers secured within the elongate support member. The flexible fibers oscillate and move about the surface of the leading edge and portions of the top surface of the wing during flight due to the airflow about the wing. The movement of the flexible fibers moves accumulated water thereby assisting in the dispersing of the water from the wing and reducing the likelihood of the water freezing upon the wing. The movement of the flexible fibers also assists in removing any accumulated ice upon the wing prior to flight. The flexible fibers are preferably constructed of a flexible material such as but not limited to plastic.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an anti-icing system that will overcome the shortcomings of the prior art devices.

A second object is to provide an anti-icing system for inhibiting the formation of ice upon the leading edge of an aircraft wing during flight.

Another object is to provide an anti-icing system that is capable of removing existing ice development upon an aircraft wing.

An additional object is to provide an anti-icing system that disturbs the formation of ice by constantly moving existing water upon the leading edge of the wing.

A further object is to provide an anti-icing system that may be installed upon existing aircraft.

Another object is to provide an anti-icing system that does not require significant maintenance.

A further object is to provide an anti-icing system that does not require the usage of deicing and anti-icing fluids.

Another object is to provide an anti-icing system that reduces costs associated with operating an aircraft in cold weather conditions.

A further object is to provide an anti-icing system that increases aircraft safety.

Another object is to provide an anti-icing system that may be utilized upon various types and sizes of aircraft.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention secured to the leading edge of an aircraft wing.

FIG. 2 is an upper perspective view of the present invention.

FIG. 3 is a magnified upper perspective view of the present invention.

FIG. 4 is a side view of the present invention secured to the leading edge of an aircraft wing with no airflow.

FIG. 5 is a side view of the present invention secured to the leading edge of an aircraft wing with airflow passing over the wing.

FIG. 6 is a side view of an alternative embodiment of the present invention.

### DESCRIPTION OF THE PREFERRED EMBODIMENT

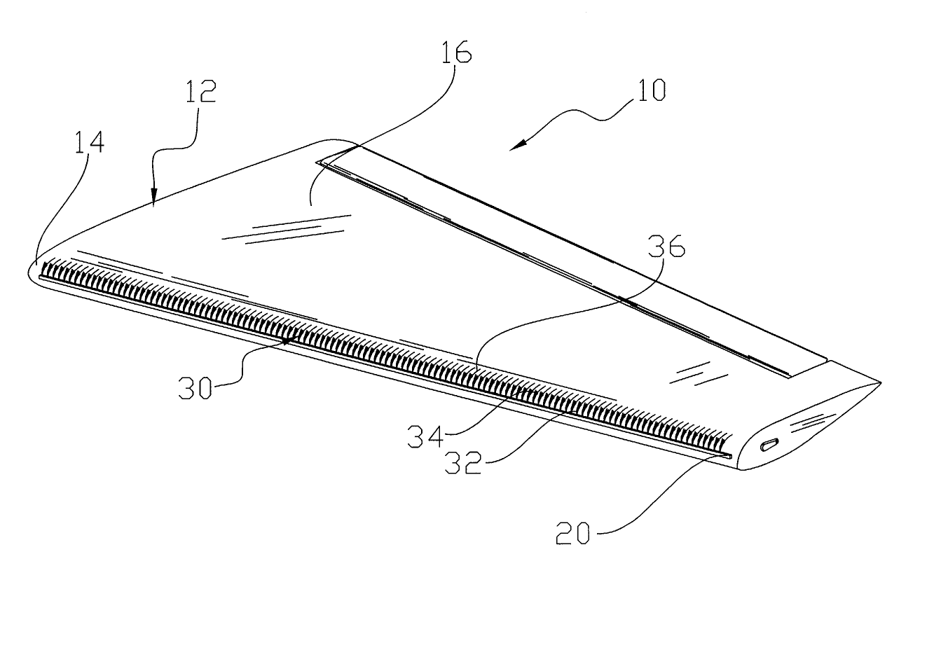

Turning now descriptively to the drawings, in which similar reference characters denote similar elements throughout the several views, FIGS. 1 through 5 illustrate an anti-icing system 10, which comprises an elongate support member 20 that is attachable to a leading edge 14 of an aircraft wing 12, and a plurality of flexible fibers 30 secured within the elongate support member 20. The flexible fibers 30 oscillate and move about the surface of the leading edge 14 and portions of the top surface 16 of the wing 12 during flight due to the airflow about the wing 12. The movement of the flexible fibers 30 moves accumulated water thereby assisting in the dispersing of the water from the wing 12 and reducing the likelihood of the water freezing upon the wing 12. The movement of the flexible fibers 30 also assists in removing any accumulated ice upon the wing 12 prior to flight. The flexible fibers 30 are preferably constructed of a flexible material such as but not limited to plastic.

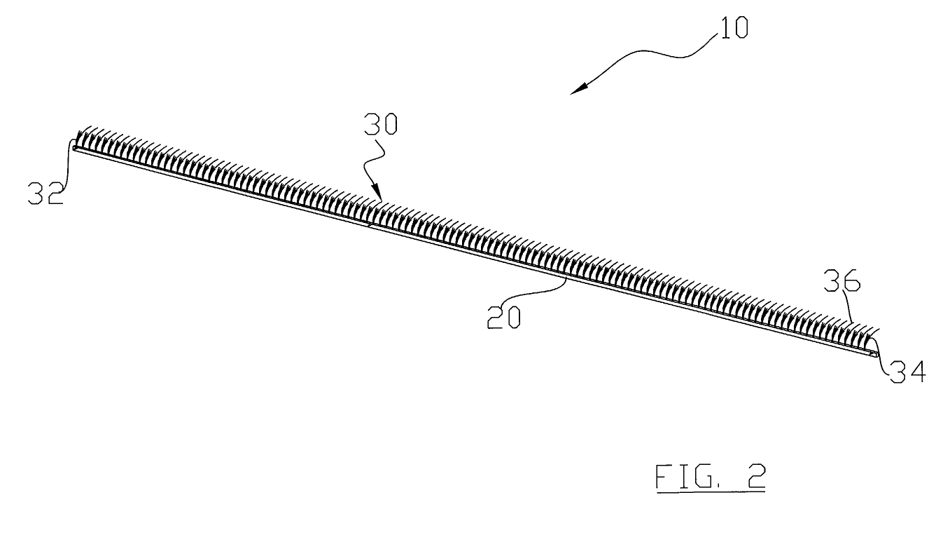

As shown in FIGS. 1 and 2 of the drawings, the support member 20 is comprised of an elongate structure. The support member 20 is preferably formed to extend across a significant portion of the leading edge 14 of the wing 12. It can be appreciated that the support member 20 may be comprised of a plurality of individual segments and similar structures. The support member 20 may be comprised of various materials such as but not limited to metal, plastic and fiber strap.

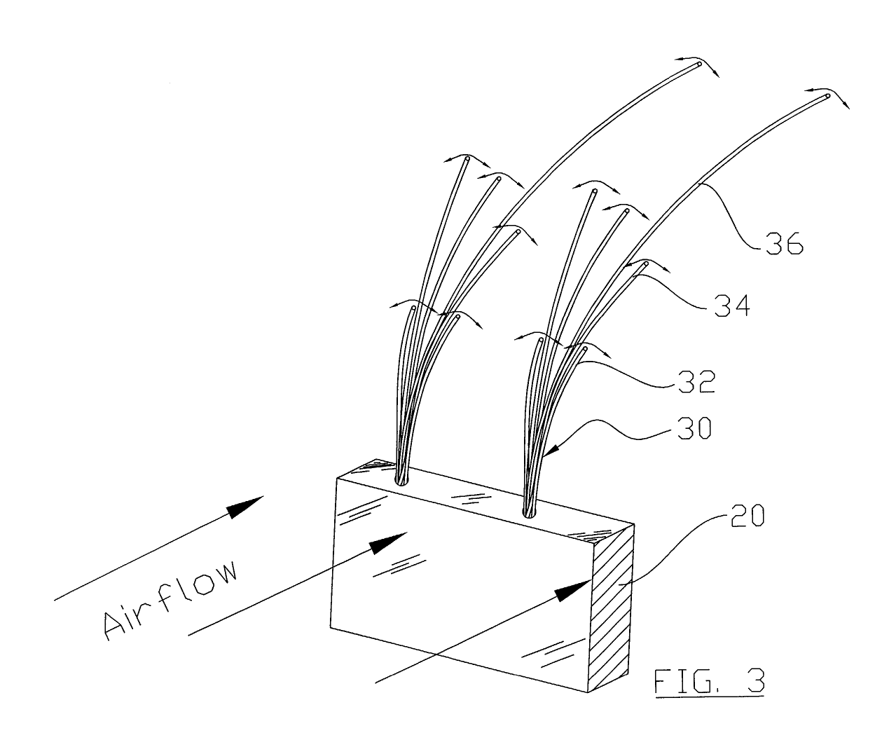

The support member 20 is preferably comprised of a generally flat structure having an upper edge as best shown in FIG. 3 of the drawings. The flat structure of the support member 20 reduces resistance during flight by conforming to the surface of the leading edge 14. As shown in FIGS. 1, 4 and 5 of the drawings, the support member 20 is preferably attached to the middle portion of the leading edge 14, however various other positions upon the leading edge 14 may be utilized. The support member 20 may be attached to the leading edge 14 utilizing conventional aircraft fasteners, adhesive or other established securing means.

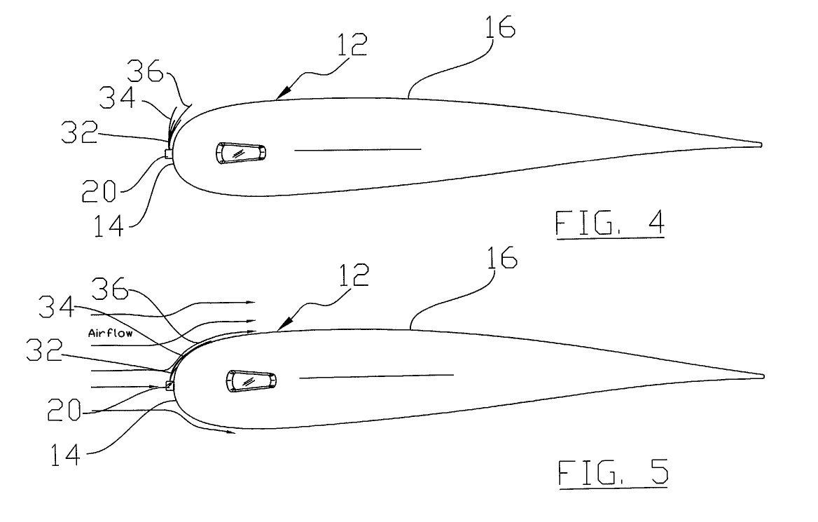

As shown in FIGS. 1 through 3 of the drawings, a plurality of flexible fibers 30 are attached to the support member 20. The plurality of flexible fibers 30 are preferably attached to the upper edge of the support member 20 and extend substantially upward as best shown in FIG. 3 of the drawings. The flexible fibers 30 may extend in a straight or curved manner as can be appreciated. For example, FIG. 4 illustrates the flexible fibers 30 in a partially curved structure drawn toward the curvature of the leading edge 14 of the wing 12. The flexible fibers 30 are preferably constructed of a flexible material such as but not limited to plastic. Various other types of materials may be utilized to construct the flexible fibers 30 as can be appreciated. The flexible fibers 30 may have various diameters and flexibility characteristics to improve the performance of the flexible fibers 30 with respect to the wing 12.

As shown in FIGS. 1 through 3 of the drawings, the flexible fibers 30 are preferably attached to the upper edge of the support member 20 in individual “bundles” in a distally spaced apart manner. It can be appreciated that the flexible fibers 30 may be secured to the support member 20 in a random manner if desired. As best shown in FIG. 3 of the drawings, the flexible fibers 30 preferably are comprised of various lengths. FIG. 3 illustrates the usage of a set of first fibers 32 having a first length, a set of second fibers 34 having a second length, and a set of third fibers 36 having a third length wherein the third fibers 36 are longer than the second fibers 34 and wherein the second fibers 34 are longer than first fibers 32. It can be appreciated that more or less sets of fibers may be utilized other than that illustrated within FIG. 3 of the drawings.

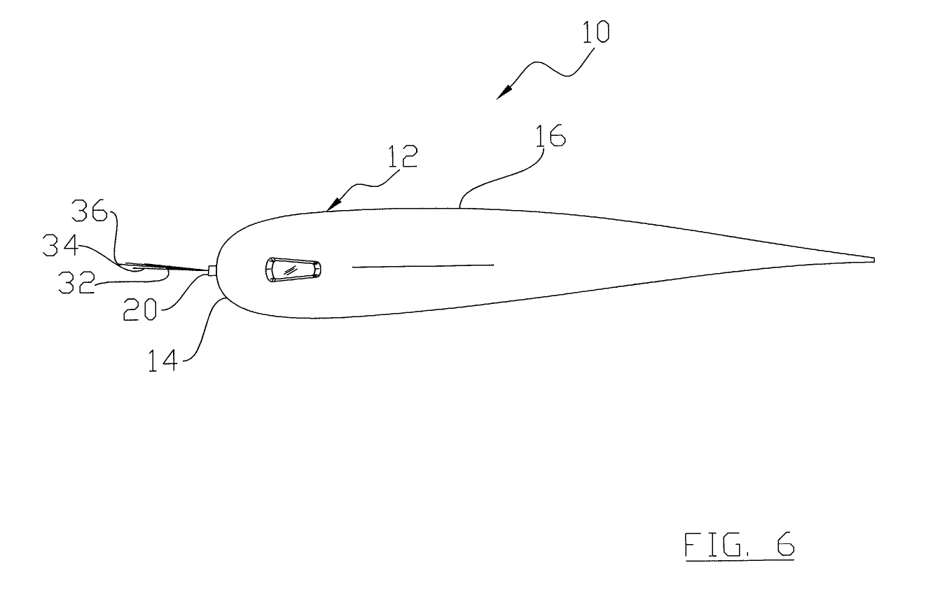

FIG. 6 illustrates an alternative embodiment of the present invention wherein the flexible fibers 30 extending from a front surface of the support member 20 in a substantially horizontal manner. The flexible fibers 30 are preferably angled slightly upwardly so as to facilitate bending of the flexible fibers 30 toward the wing 12 during operation of the aircraft. Various other angles may be utilized with respect to the flexible fibers 30.

In use, the support member 20 containing the flexible fibers 30 is secured to the leading edge 14 of the aircraft wing 12. During take-off and flight, the airflow about the wing 12 causes the flexible fibers 30 to conform to the surface of the wing 12 and oscillate about thereby moving accumulated water from the leading edge 14 of the wing 12. The longer flexible fibers 30 extend upwardly upon an initial portion of the top surface 16 to assist in diverting the accumulated water during flight. The movement of the flexible fibers 30 also assists in the removal of accumulated ice upon the leading edge 14 of the wing 12 by directly engaging the ice and removing the ice over a period of time.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An anti-icing system for a wing of an aircraft, comprising:
a support member attachable to a leading edge of a wing; and
a plurality of flexible fibers attached to said support member and extending substantially upwardly from said support member, wherein said plurality of flexible fibers movably engage an upper portion of a leading edge of a wing during flight in an oscillating manner.

2. The anti-icing system of claim 1, wherein said support member is substantially a length of a wing of an aircraft.

3. The anti-icing system of claim 1, wherein said support member has a substantially flat structure.

4. The anti-icing system of claim 3, wherein said support member has an upper edge and wherein said plurality of flexible fibers are attached within said upper edge of said support member.

5. The anti-icing system of claim 4, wherein said upper edge is substantially orthogonal with respect to a front surface of said support member.

6. The anti-icing system of claim 1, wherein said support member is formed to a surface shape of a leading edge of an aircraft.

7. The anti-icing system of claim 1, wherein said plurality of flexible fibers are comprised of various lengths.

8. The anti-icing system of claim 7, wherein said plurality of flexible fibers are comprised of a set of first fibers having a first length, a set of second fibers having a second length and a set of third fibers having a third length, wherein said third fibers are longer than said second fibers and wherein said second fibers are longer than first fibers.

9. The anti-icing system of claim 8, wherein said plurality of flexible fibers are comprised of a plastic material.

10. The anti-icing system of claim 1, wherein said plurality of flexible fibers are each comprised of a consistent diameter.

11. An anti-icing system for a wing of an aircraft, comprising:
a support member attachable to a leading edge of a wing; and
a plurality of flexible fibers attached to said support member and extending substantially upwardly from said support member formed into a plurality of individual sets distally spaced apart from one another, wherein said plurality of flexible fibers movably engage an upper portion of a leading edge of a wing during flight in an oscillating manner.

12. The anti-icing system of claim 11, wherein said support member is substantially a length of a wing of an aircraft.

13. The anti-icing system of claim 11, wherein said support member has a substantially flat structure.

14. The anti-icing system of claim 13, wherein said support member has an upper edge and wherein said plurality of flexible fibers are attached within said upper edge of said support member.

15. The anti-icing system of claim 14, wherein said upper edge is substantially orthogonal with respect to a front surface of said support member.

16. The anti-icing system of claim 11, wherein said support member is formed to a surface shape of a leading edge of an aircraft.

17. The anti-icing system of claim 11, wherein said plurality of flexible fibers are comprised of various lengths.

18. The anti-icing system of claim 17, wherein said plurality of flexible fibers are comprised of a set of first fibers having a first length, a set of second fibers having a second length and a set of third fibers having a third length, wherein said third fibers are longer than said second fibers and wherein said second fibers are longer than first fibers.

19. The anti-icing system of claim 18, wherein said plurality of flexible fibers are comprised of a plastic material.

20. The anti-icing system of claim 11, wherein said plurality of flexible fibers are each comprised of a consistent diameter.
